(19) United States
(12) Patent Application Publication
(10) Pub. No.: US 2024/0243524 A1
(43) Pub. Date: Jul. 18, 2024

(54) SHIELDED KEYSTONE STYLE PUNCHDOWN JACK

(71) Applicant: Panduit Corp., Tinley Park, IL (US)

(72) Inventors: Roman J. Churnovic, Manhattan, IL (US); Robert E. Fransen, Orland Park, IL (US)

(73) Assignee: Panduit Corp., Tinley Park, IL (US)

(21) Appl. No.: 18/216,252

(22) Filed: Jun. 29, 2023

Related U.S. Application Data
(63) Continuation-in-part of application No. 18/098,183, filed on Jan. 18, 2023.

(51) Int. Cl. H01R 13/6581; H01R 13/506; H01R 13/6591

(52) U.S. Cl. CPC H01R 13/6581; H01R 13/506; H01R 13/65912

(57) ABSTRACT

A rear wire cover assembly for a keystone style punchdown jack has a shield wrap and an opening configured to allow the rear wire cover assembly to move in a direction perpendicular to an axis of the cable such as to partially enclose the cable and also such as to allow the rear wire cover assembly to move along the axis of the cable to engage a rear of the keystone style punchdown jack.

### CROSS REFERENCE TO RELATED APPLICATION

This application is a continuation-in-part of U.S. patent application Ser. No. 18/098,183, filed on Jan. 18, 2023, the entirety of which is hereby incorporated by reference herein.

### FIELD OF THE INVENTION

The present invention is related generally to RJ45 style connectors and more specifically to a keystone style punchdown jack with a rear wire cover assembly.

### BACKGROUND

The market currently offers several Mini-Com shielded TG jack modules and several unshielded keystone style punchdown jack modules. What is needed is a shielded keystone jack that utilizes the existing punchdown style termination method and is cost competitive to existing shielded Mini-Com jacks with a TG style termination method. Specifically, one with a rear wire cover assembly that can electrically connect a braid of a shielded cable to the shield of the jack and secure conductors to the shield of the jack.

### SUMMARY

A rear wire cover assembly for a keystone style punchdown jack has a shield wrap and an opening configured to allow the rear wire cover assembly to move in a direction perpendicular to an axis of the cable such as to partially enclose the cable and also such as to allow the rear wire cover assembly to move along the axis of the cable to engage a rear of the keystone style punchdown jack.

### BRIEF DESCRIPTION OF THE FIGURES

FIG. 1 is an isometric view of communications system 10.

FIG. 2 is an isometric exploded view of terminated jack assembly 16.

FIG. 3 is a front top exploded view of jack housing assembly 26.

FIG. 4 is a front bottom exploded view of jack housing assembly 26.

FIG. 5 is a rear top exploded view of jack housing assembly 26.

FIG. 6 depicts front shield wrap 30 in its open state prior to the final forming.

FIG. 7 is a front top view of jack housing assembly 26.

FIG. 8 is a front bottom view of jack housing assembly 26.

FIG. 9 is a rear top view of jack housing assembly 26 with front shield wrap 30 in its open state.

FIG. 10 is a rear bottom view of jack housing assembly 26 with front shield wrap 30 in its open state.

FIG. 11 is a front top view of jack housing assembly 26 with front shield wrap 30 in its closed state.

FIG. 12 is a front bottom view of jack housing assembly 26 with front shield wrap 30 in its closed state.

FIG. 13 is a rear top view of jack housing assembly 26 with front shield wrap 30 in its closed state.

FIG. 14 is a rear bottom view of jack housing assembly 26 with front shield wrap 30 in its closed state.

FIG. 15 is a front top exploded view of rear wire cover assembly 28.

FIG. 16 is a rear bottom exploded view of rear wire cover assembly 28.

FIG. 17 is a front top view of rear wire cover assembly 28.

FIG. 18 is a section view of communications system 10 taken about the center line of conductor 88₄ and conductor 88₇ of an unmated terminated jack assembly 16 secured to shielded patch panel 12.

FIG. 19 is a front top view of terminated jack assembly 16.

FIG. 20 is a rear top view of terminated jack assembly 16.

FIG. 21 is a rear top view of alternate terminated jack assembly 17.

FIG. 22 is an isometric exploded view of alternate embodiment terminated jack assembly 216.

FIG. 23 is a rear top view of jack housing assembly 226 with front shield wrap 230 in its open state.

FIG. 24 is a rear bottom view of jack housing assembly 226 with front shield wrap 230 in its open state.

FIG. 25 is a front top exploded view of rear wire cover assembly 228.

FIG. 26 is a rear bottom exploded view of rear wire cover assembly 228.

FIG. 27 is a front top view of rear wire cover assembly 228.

FIG. 28 is a section view of communications system 210 taken about the center line of conductor 88₄ and conductor 88₇ of an unmated terminated jack assembly 216 secured to shielded patch panel 12.

FIG. 29 is a front top view of terminated jack assembly 216.

FIG. 30 is a rear top view of terminated jack assembly 216.

### DESCRIPTION OF THE INVENTION

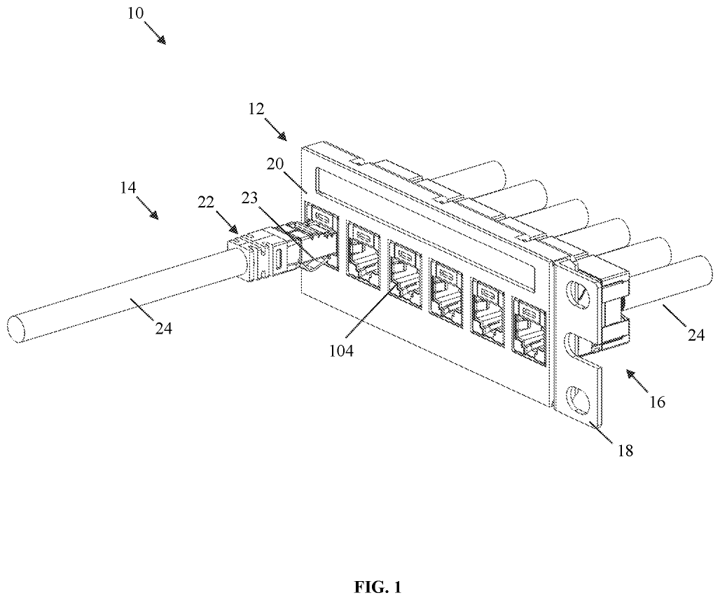

FIG. 1 is an isometric view of communications system 10 which includes shielded patch panel 12, patch cord assembly 14, and terminated jack assemblies 16. Communications system 10, 210 can further include cabinets, racks, cable management, patch panels, overhead routing systems, horizontal cabling, and other such equipment. Shielded patch panel 12 includes formed metal panel 18 and faceplate insert 20. Patch cord assembly 14 includes shielded plug assembly 22 and shielded cable 24.

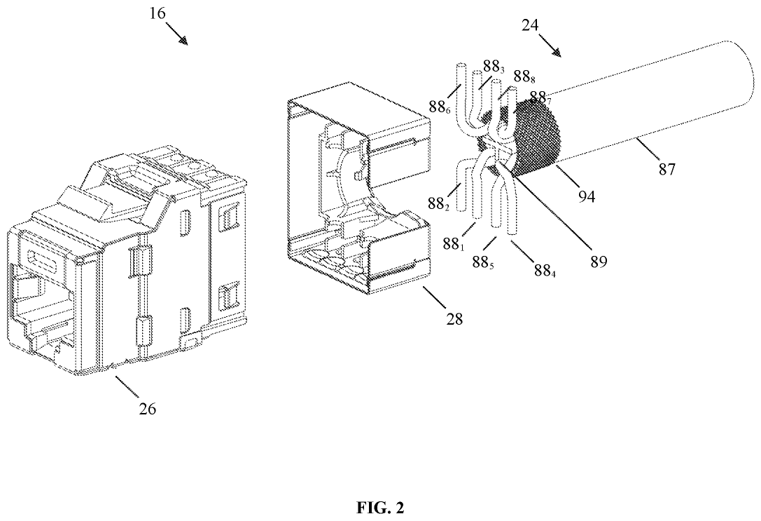

FIG. 2 is an isometric exploded view of terminated jack assembly 16. Terminated jack assembly 16 includes shielded cable 24, jack housing assembly 26, and rear wire cover assembly 28. Shielded cable 24 includes cable jacket 87, conductors 88, conductor divider 89, and braid 94.

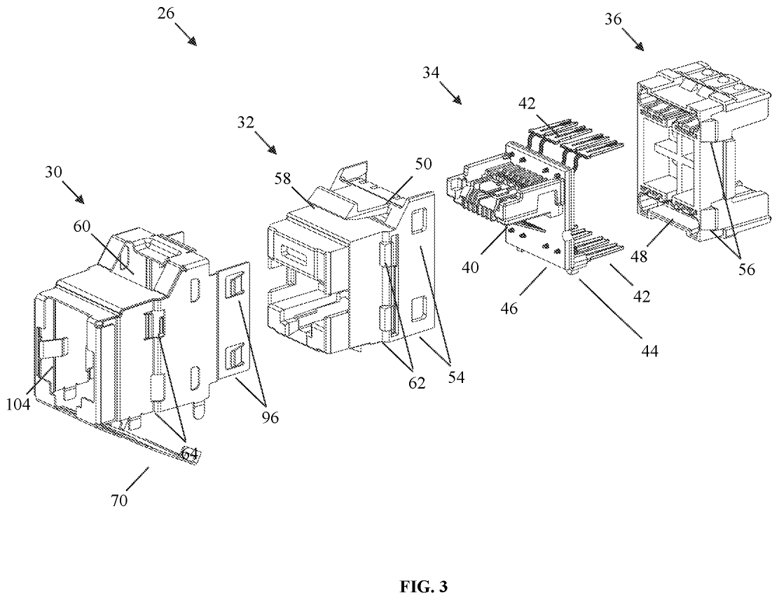

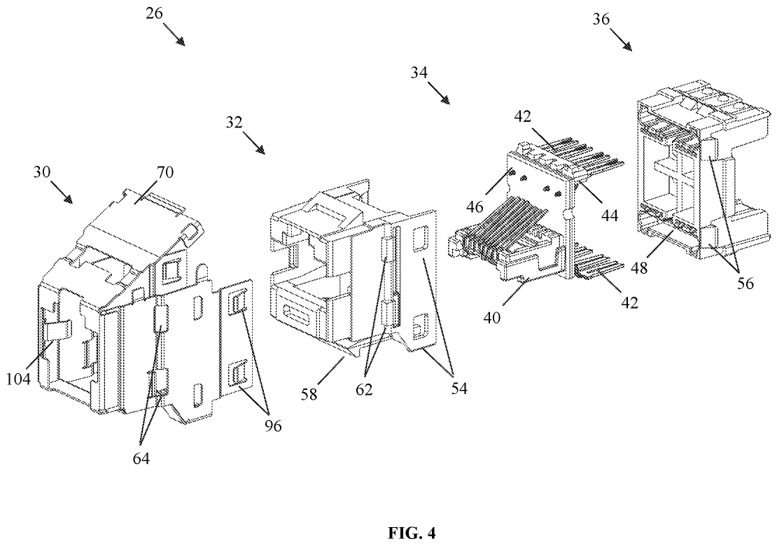

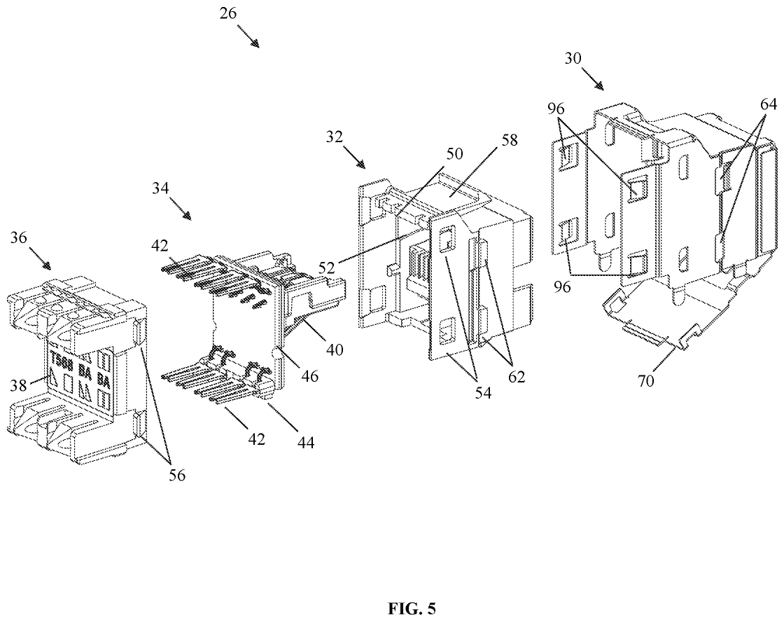

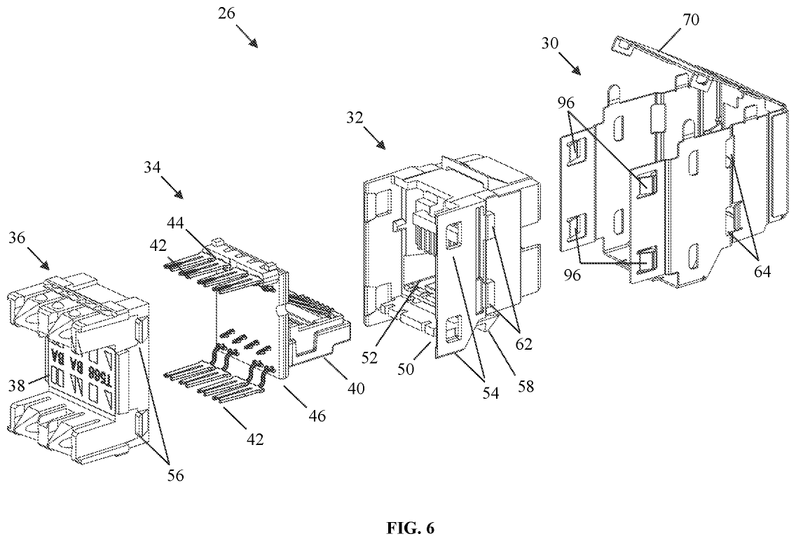

FIG. 3 is a front top exploded view of jack housing assembly 26. FIG. 4 is a front bottom exploded view of jack housing assembly 26. FIG. 5 is a rear top exploded view of jack housing assembly 26. FIG. 6 is a rear bottom exploded view of jack housing assembly 26. Jack housing assembly 26 includes front shield wrap 30, jack housing 32, PCB assembly 34, rear sled 36, and wire map label 38 (FIG. 5-FIG. 6). FIG. 3-FIG. 6 depict front shield wrap 30 in its open state prior to the final forming. PCB assembly 34 includes sled assembly 40, long IDCs 42, IDC Support 44, and PCB 46. PCB assembly 34 is constructed and utilized in a manner identical to current production unshielded keystone punchdown jack modules.

Long IDCs 42 of PCB assembly 34 are press fit into channels 48 of rear sled 36 to keep long IDCs 42 constrained during the termination process. IDC support 44 of PCB assembly 34 and lower support wall 50 of jack housing 32 provide support to long IDCs 42 of PCB assembly 34 during the assembly process. Sled assembly 40 of PCB assembly 34 slides into opening 52 on jack housing 32 (FIG. 5-FIG. 6). D-window latches 54 on jack housing 32 snap over catches 56 of rear sled 36 to secure components together. Wire map label 38 has an adhesive backing that secures it to rear sled 36. Jack housing 32, PCB assembly 34, rear sled 36, and wire map label 38, in an assembled state, are slid into front shield wrap 30. Flexible latch 58 on jack housing 32 slides through opening 60 of front shield wrap 30. Side stops 62 of jack housing 32 pass through windows 64 of front shield wrap 30 and help keep all components from separating prior to the final forming of front shield wrap 30.

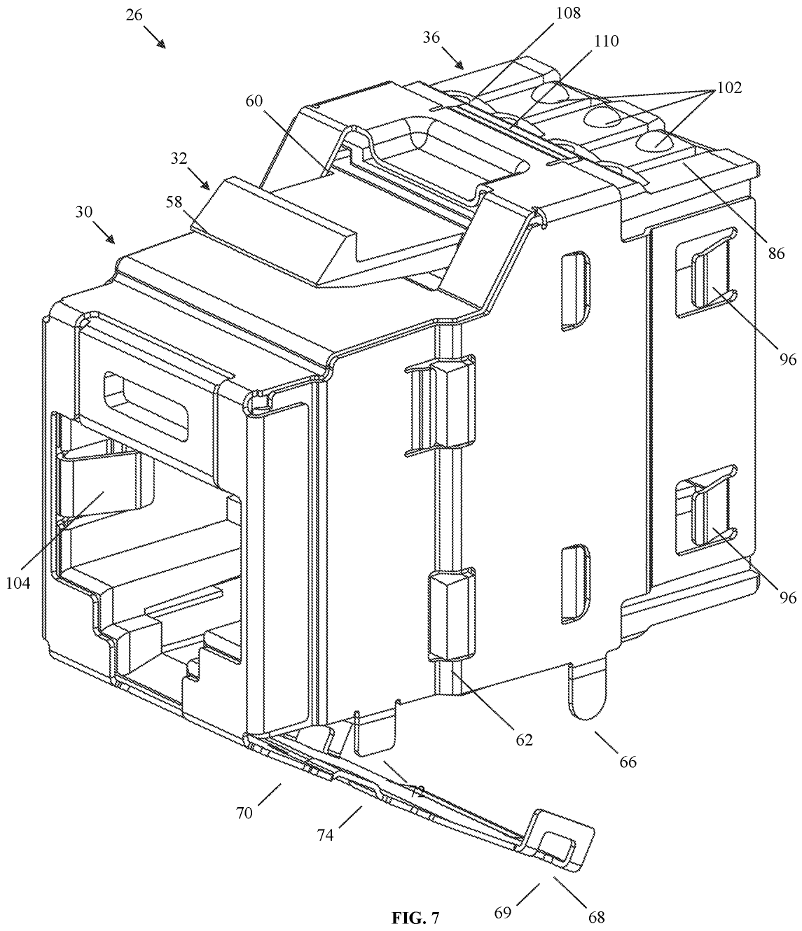

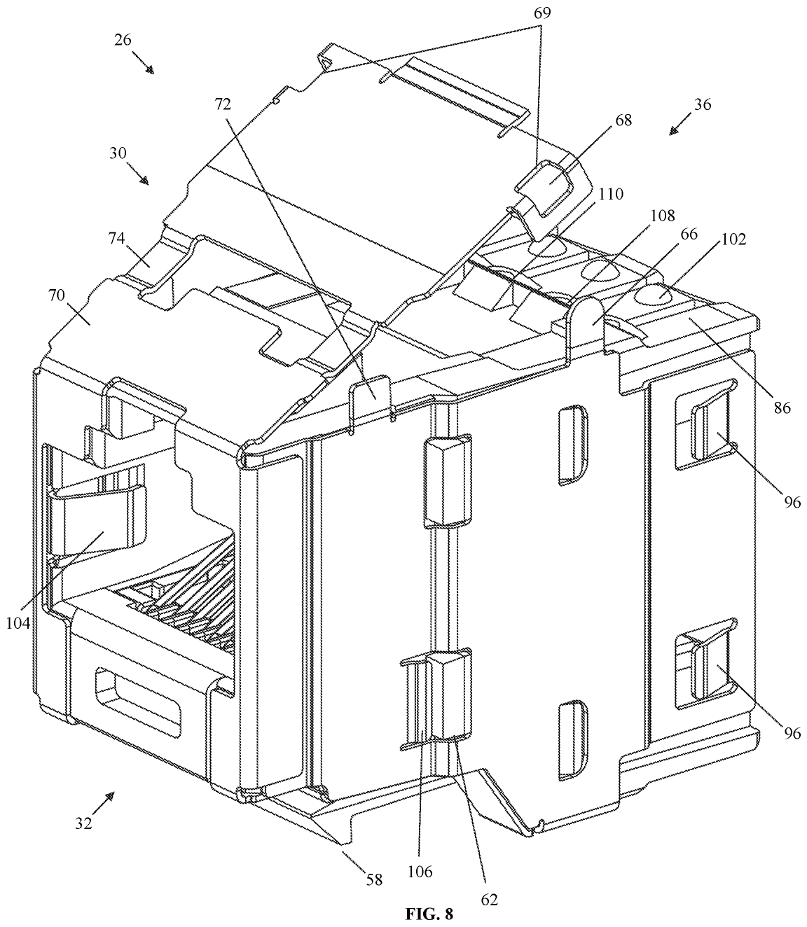

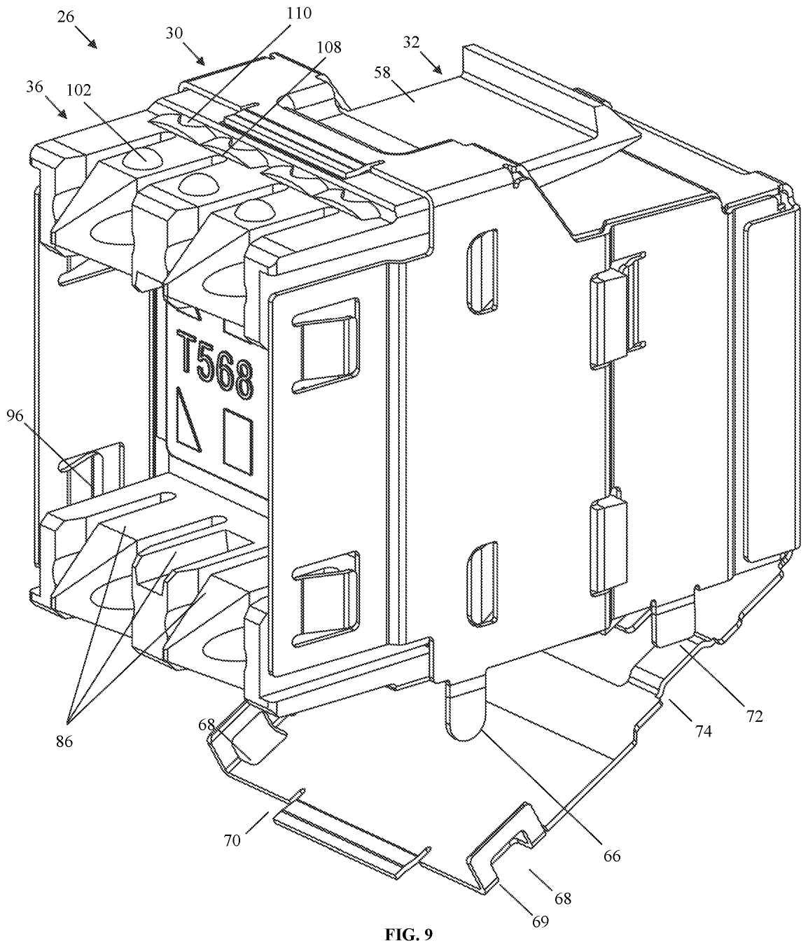

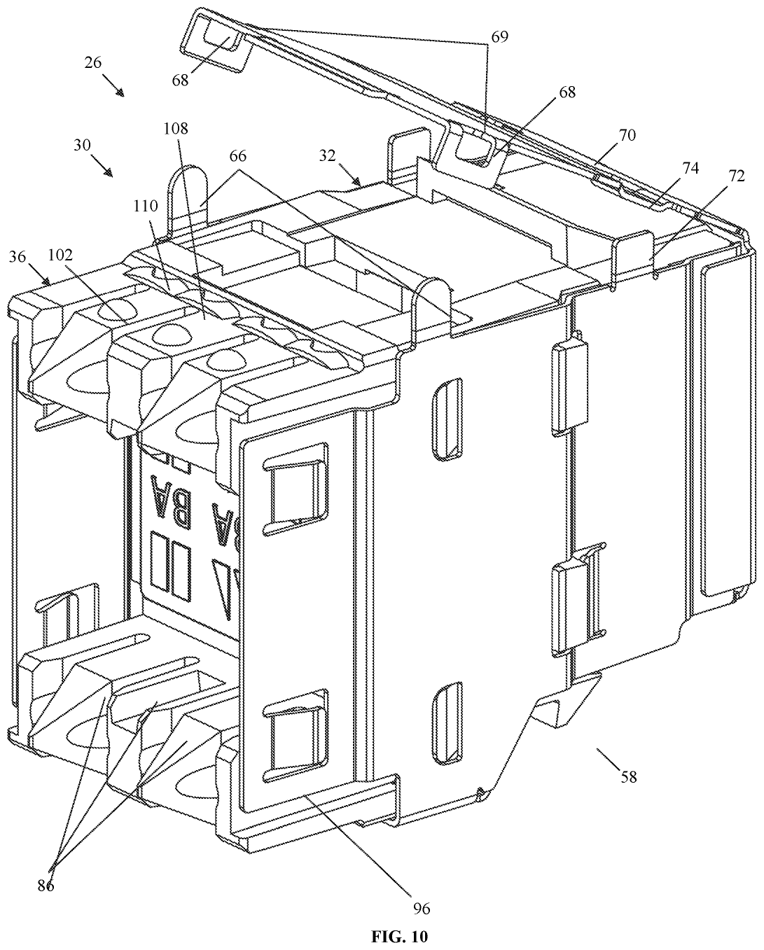

FIG. 7 is a front top view of jack housing assembly 26 with front shield wrap 30 in its open state prior to the final assembly. FIG. 8 is a front bottom view of jack housing assembly 26 with front shield wrap 30 in its open state. FIG. 9 is a rear top view of jack housing assembly 26 with front shield wrap 30 in its open state. FIG. 10 is a rear bottom view of jack housing assembly 26 with front shield wrap 30 in its open state. Rear tabs 66 pass through holes 68 as flange 70 is brought to a final position for front shield wrap 30. Rear tabs 66 are then formed over edges 69 of holes 68 to secure front shield wrap 30 in a locked position. Front tabs 72 are formed over offset geometry 74 on flange 70 of front shield wrap 30 for added security and shielding continuity.

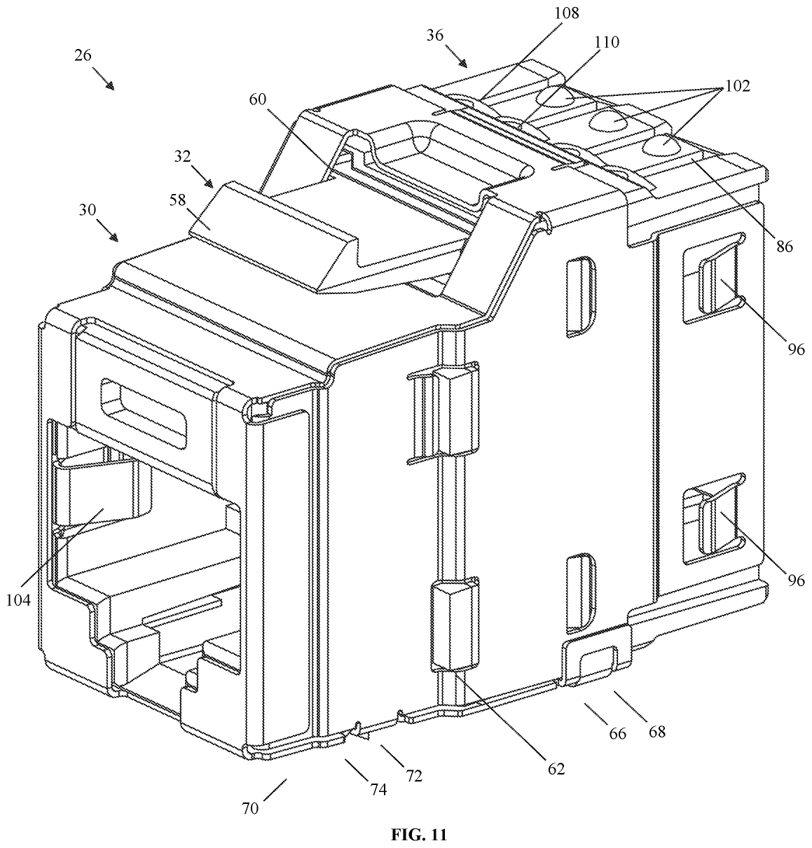

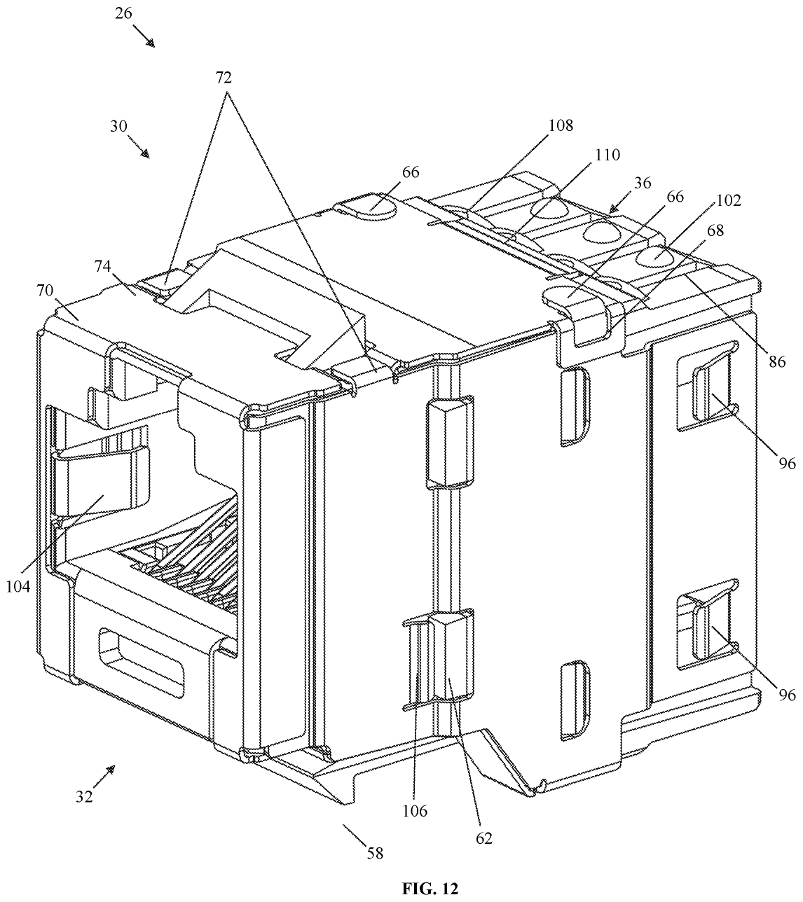

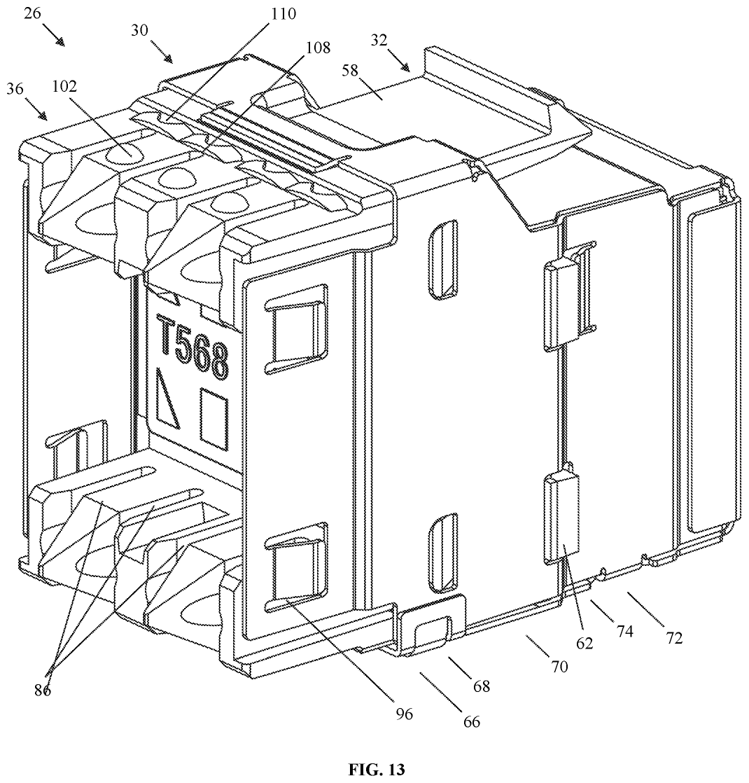

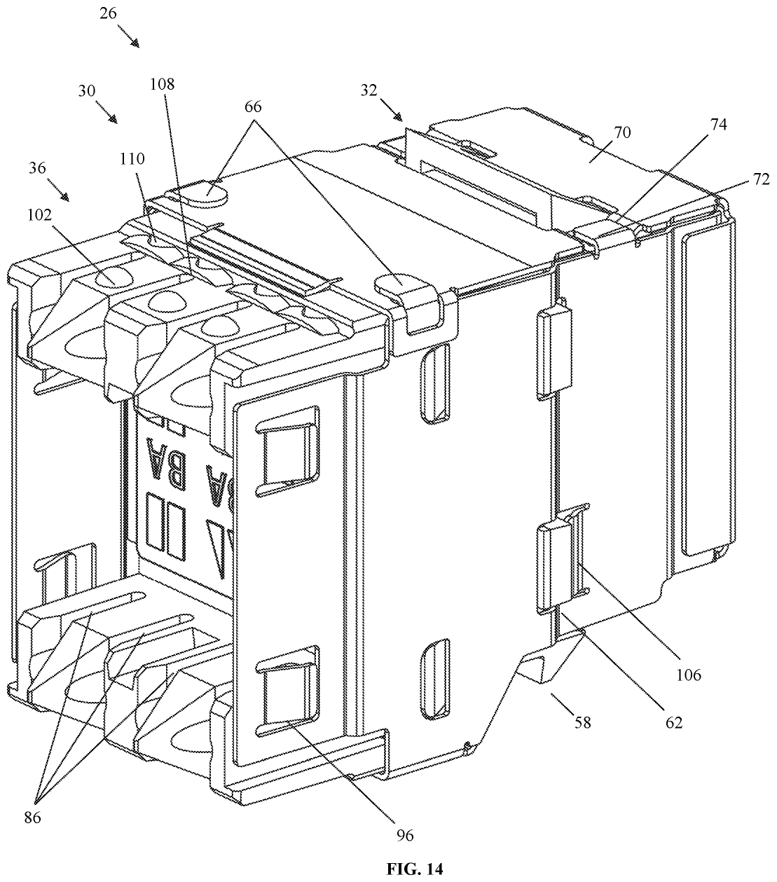

FIG. 11 is a front top view of jack housing assembly 26 with front shield wrap 30 in its closed state. FIG. 12 is a front bottom view of jack housing assembly 26 with front shield wrap 30 in its closed state. FIG. 13 is a rear top view of jack housing assembly 26 with front shield wrap 30 in its closed state. FIG. 14 is a rear bottom view of jack housing assembly 26 with front shield wrap 30 in its closed state.

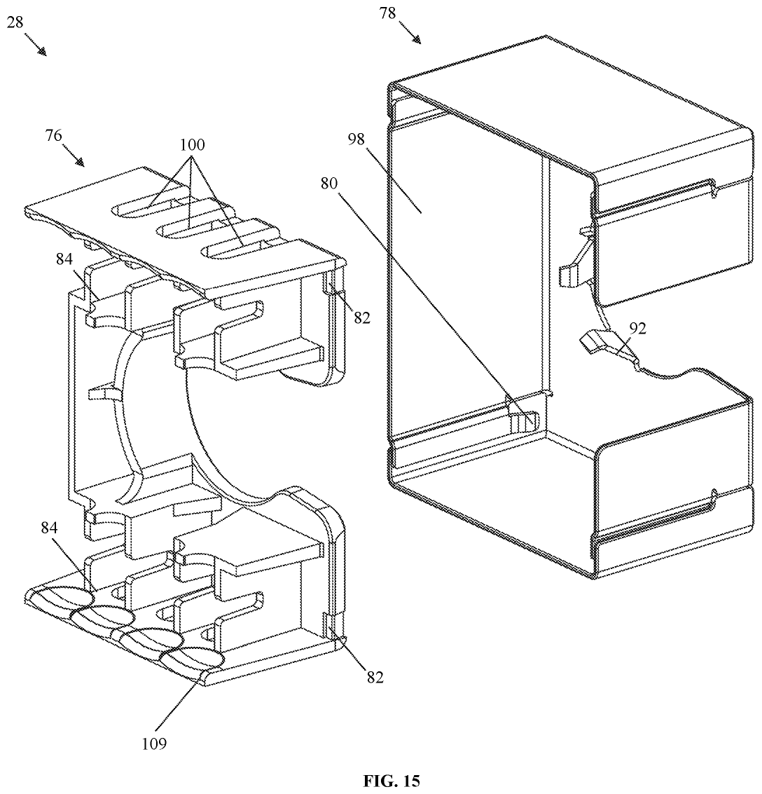

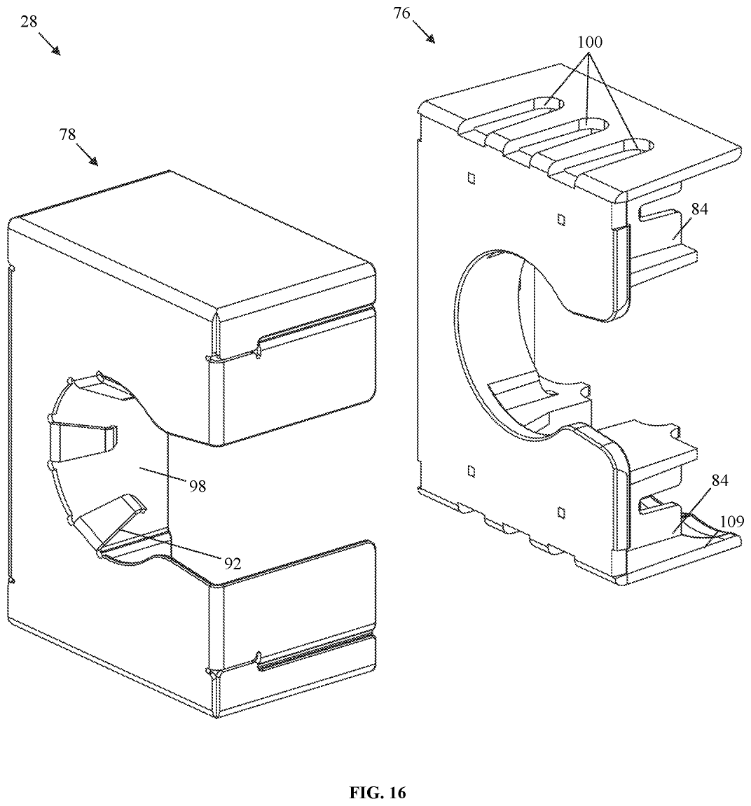

FIG. 15 is a front top exploded view of rear wire cover assembly 28. FIG. 16 is a rear bottom exploded view of rear wire cover assembly 28. Rear wire cover assembly 28 includes wire cover 76 and wire cover shield wrap 78. Wire cover 76 is placed into wire cover shield wrap 78. Return flanges 80 on wire cover shield wrap 78 catch to flat edges 82 on wire cover 76 to secure the components together.

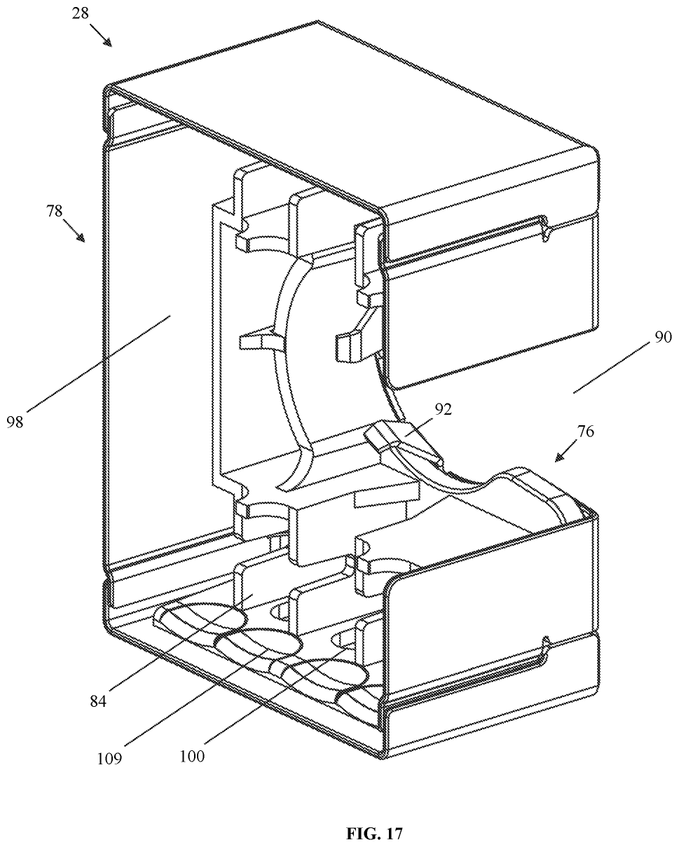

FIG. 17 is a front top view of rear wire cover assembly 28. Rear wire cover assembly 28 is symmetrically designed to allow cable opening 90 to point to either the left or right after final assembly.

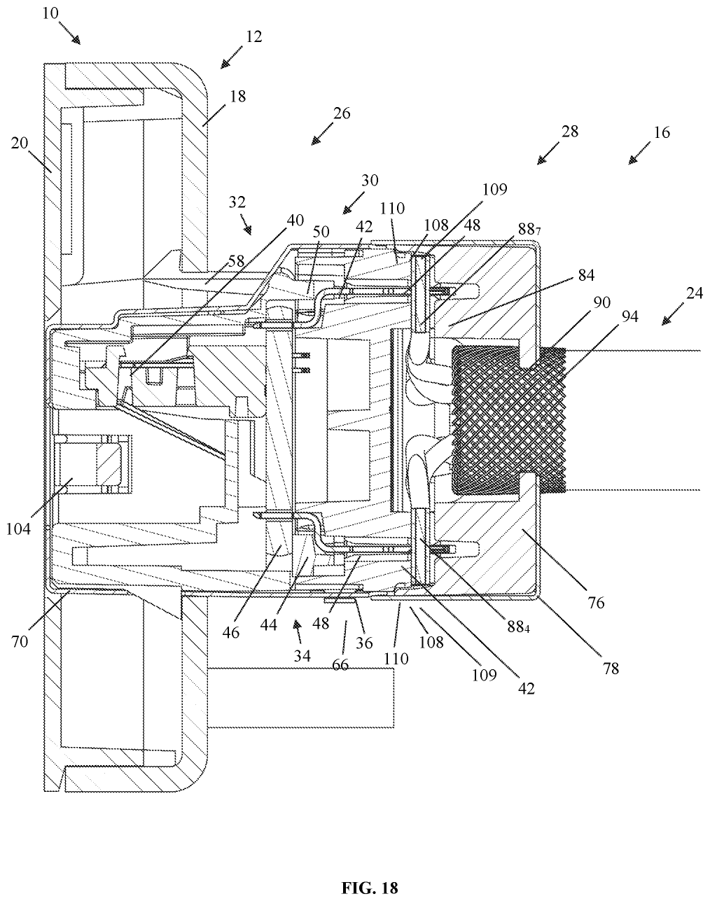

FIG. 18 is a section view of communications system 10 taken about the center line of conductor 88₄ and conductor 88₇ of an unmated terminated jack assembly 16 secured to shielded patch panel 12. Conductors 88 on shielded cable 24 are pressed into slots 86 (FIG. 7-FIG. 14) of rear sled 36 and terminated to long IDCs 42 of jack housing assembly 26. Cut edge 108 on rear sled 36 provides a flat surface for a punchdown tool to trim conductors 88 flush. Cable opening 90 on rear wire cover assembly 28 allows for rear wire cover assembly 28 to be placed onto jack housing assembly 26 after shielded cable 24 has been terminated to long IDCs 42 of jack housing assembly 26. Rear wire cover assembly 28 is then placed over the back end of jack housing assembly 26. If the ends of conductors 88 are cut too long or cut without the use of a punchdown tool after termination; rounded surfaces 109 on wire cover 76 of rear wire cover assembly 28 help to push excess conductor or dielectric length into overflow channels 110 on rear sled 36 of jack housing assembly 26.

Grounding prongs 92 on wire cover shield wrap 78 of rear wire cover assembly 28 bond to braid 94 of shielded cable 24. Wiping tabs 96 (FIG. 3-FIG. 14) on front shield wrap 30 of jack housing assembly 26 make connection to inside walls 98 (FIG. 15-FIG. 17) on wire cover shield wrap 78 of rear wire cover assembly 28 to create a fully bonded assembly. Capture slots 100 (FIG. 15-FIG. 17) on wire cover 76 of rear wire cover assembly 28 pass over round bosses 102 (FIG. 7-FIG. 14) on rear sled 36 of jack housing assembly 26 and secure rear wire cover assembly 28 to finalize terminated jack assembly 16. Divider walls 84 on wire cover 76 of rear wire cover assembly 28 slide into slots 86 of rear sled 36 of jack housing assembly 26 and help to secure conductors 88 on shielded cable 24.

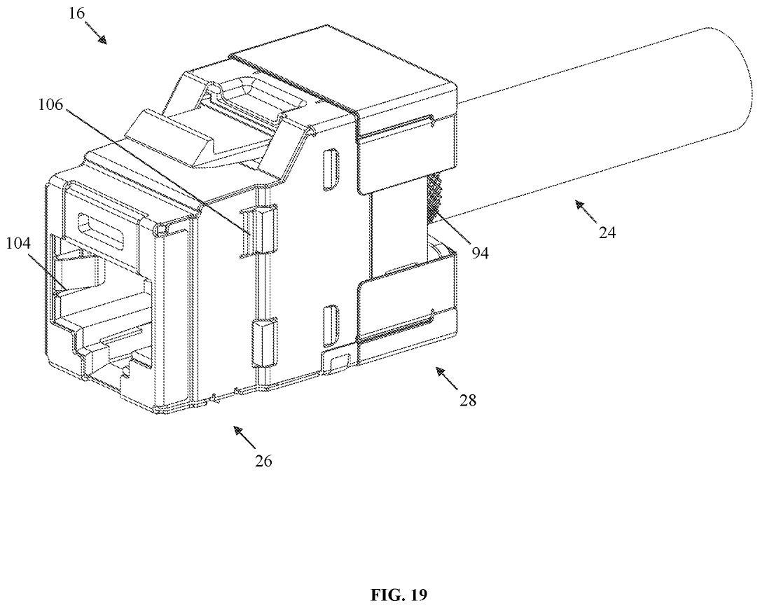

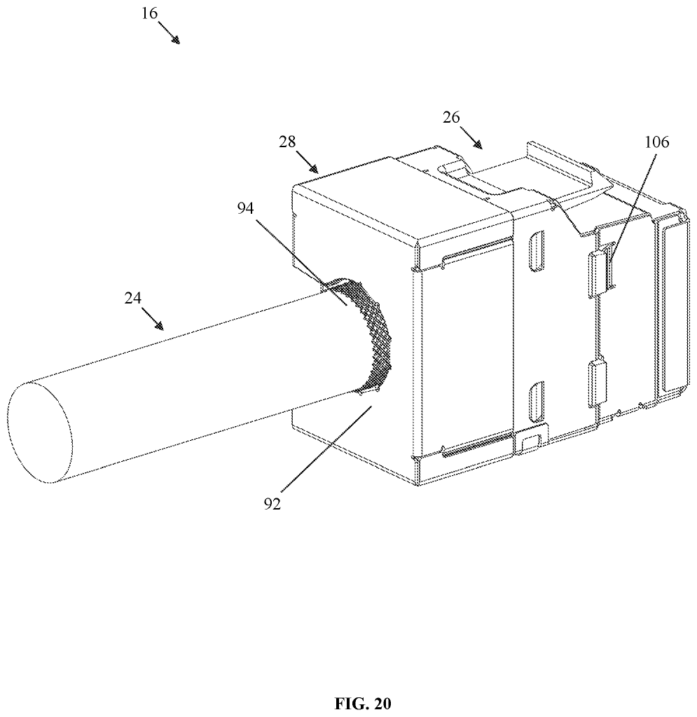

FIG. 19 is a front top view of terminated jack assembly 16. FIG. 20 is a rear top view of terminated jack assembly 16. Inner wiping tabs 104 provide a bond between plug shield 23 (FIG. 1) on shielded plug assembly 22 when shielded plug assembly 22 and terminated jack assembly 16 are in a mated state. Grounding tabs 106 are designed to bond terminated jack assembly 16 to shielded patch panel 12 when parts are assembled.

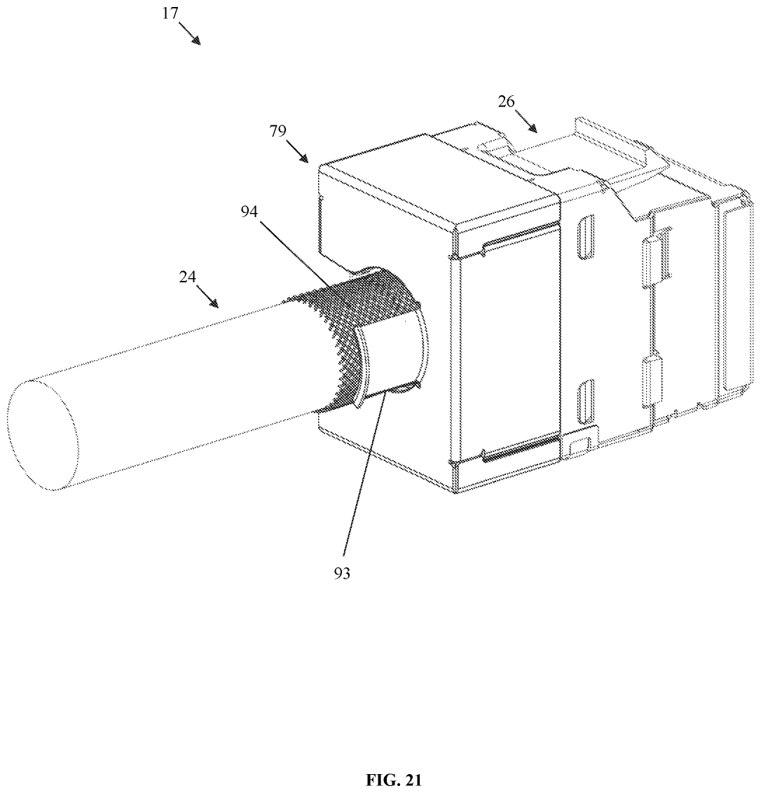

FIG. 21 is a rear top view of alternate terminated jack assembly 17. Terminated jack assembly 17 includes all of the same components as terminated jack assembly 16, with the exception of alternate wire cover shield wrap 79. Alternate wire cover shield wrap 79 has identical internal geometry as wire cover shield wrap 78, but instead of inward facing grounding prongs 92, alternate wire cover shield wrap 79 includes grounding flange 93. Grounding flange 93 is an outward facing flange designed to bond around braid 94 of shielded cable 24 with the aid of a cable tie (not pictured).

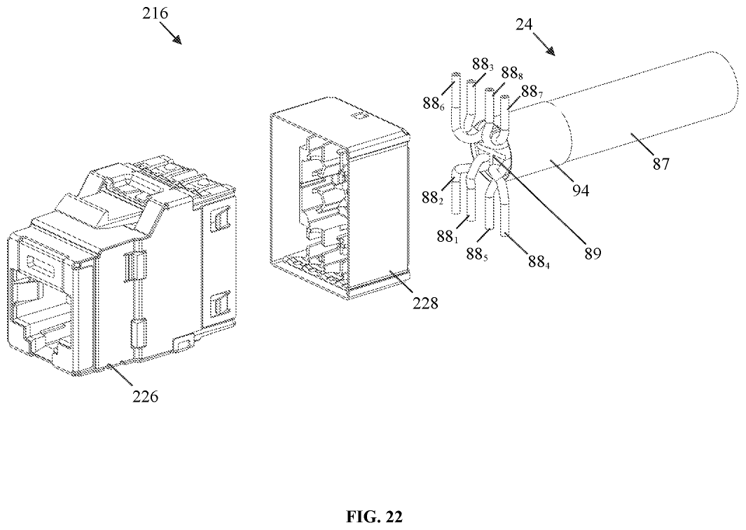

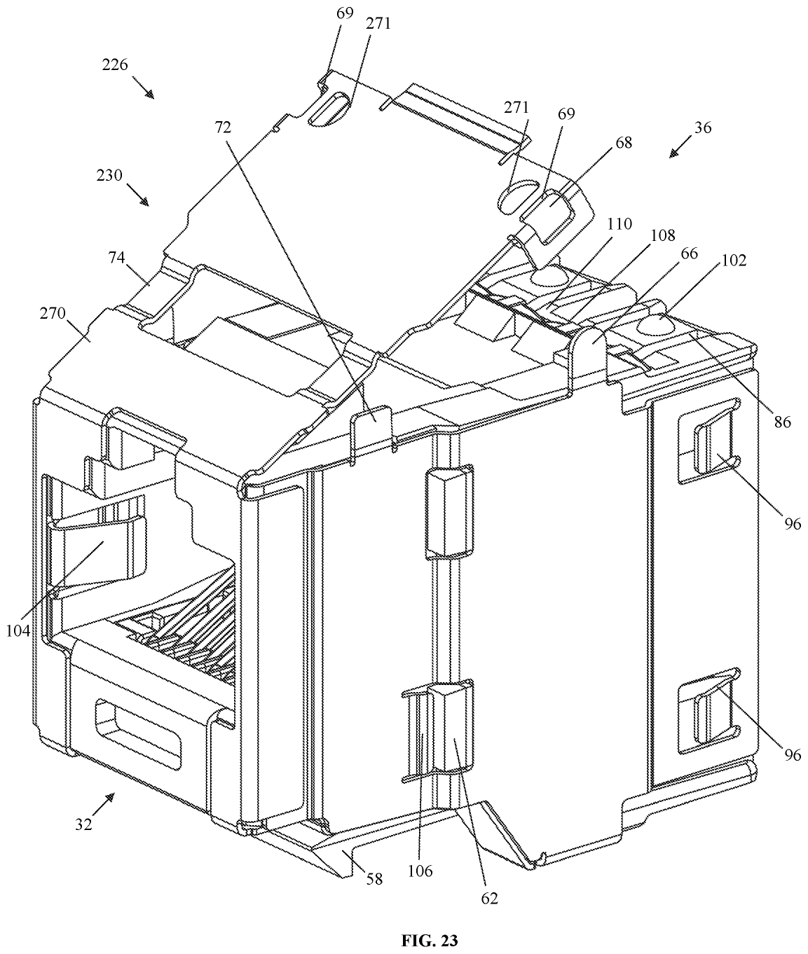

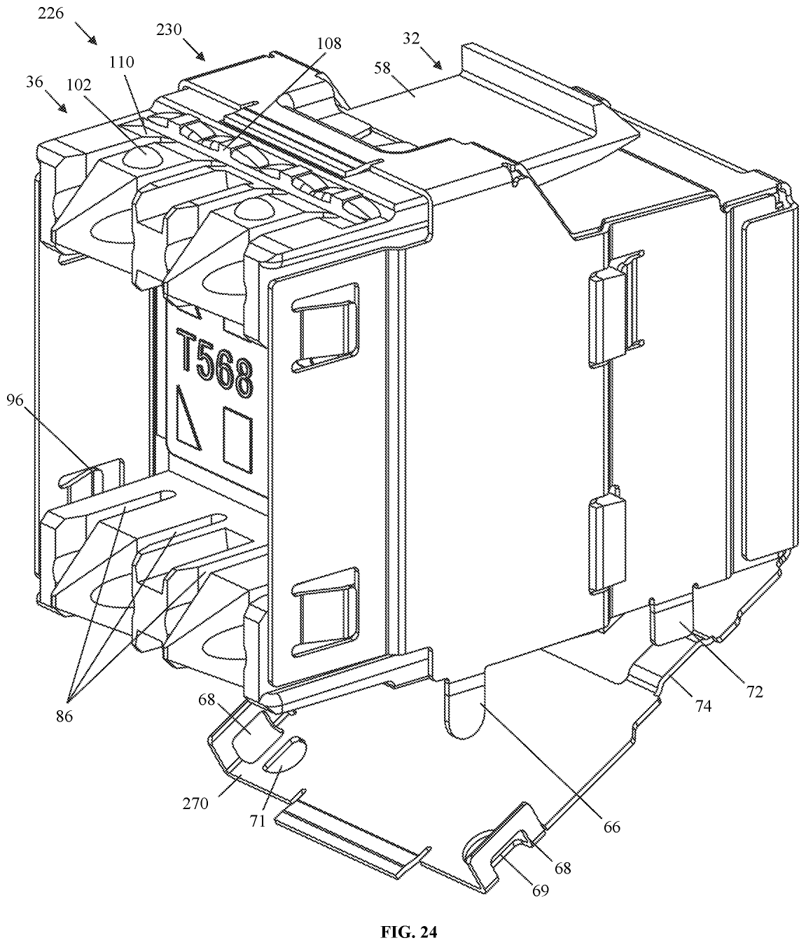

FIG. 22 is an isometric exploded view of alternate embodiment terminated jack assembly 216. FIGS. 23 and 24 show alternate terminated jack assembly 216 with jack housing assembly 226 which is similar to jack housing assembly 26 except front shield wrap 230 has cutouts 271 on flange 270.

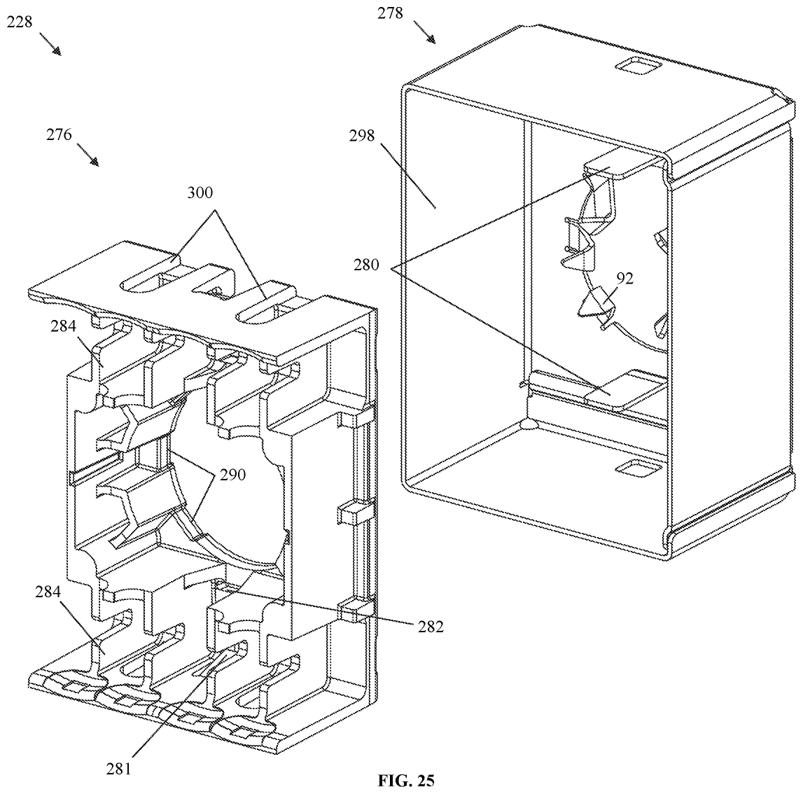

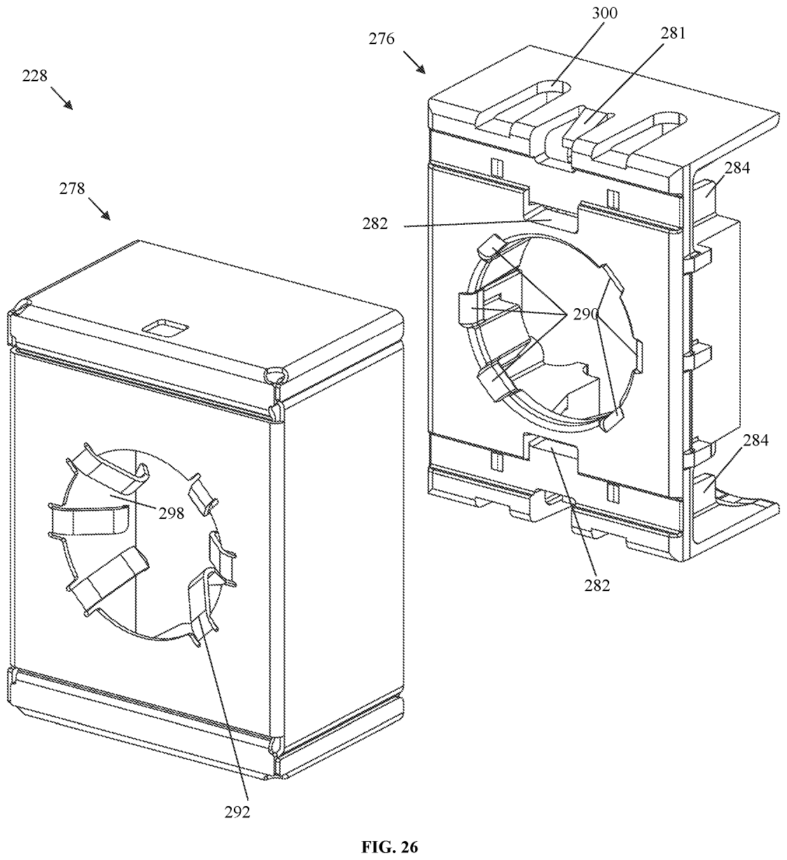

FIG. 25 is a front top exploded view of alternate rear wire cover assembly 228. FIG. 26 is a rear bottom exploded view of rear wire cover assembly 228. Rear wire cover assembly 228 includes wire cover 276 and wire cover shield wrap 278. Wire cover 276 is placed into wire cover shield wrap 278. Wire cover shield wrap 278 is shown in its open position prior to final assembly. Securing flanges 280 on wire cover shield wrap 278 pass through slots 282 on wire cover 276 and are formed around edges 277 to secure the components together. Spring latches 281 on wire cover 276 help to contain securing flanges 280 after they are formed into their final position.

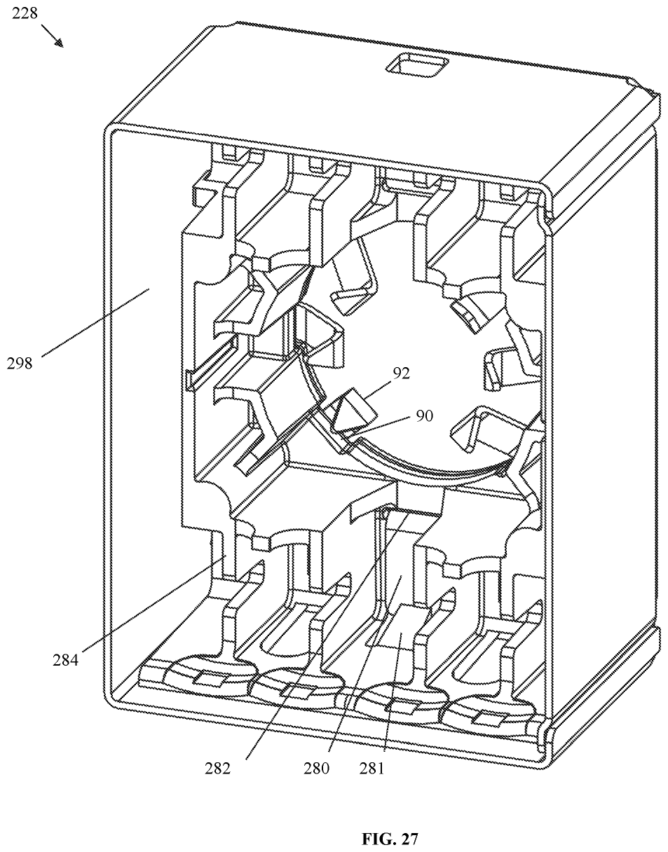

FIG. 27 is a front top view of rear wire cover assembly 228 in its final assembled state. Rear wire cover assembly 228 is symmetrically designed and can be assembled to jack housing assembly 226 in the orientation shown or rotated 180-degrees about the central axis.

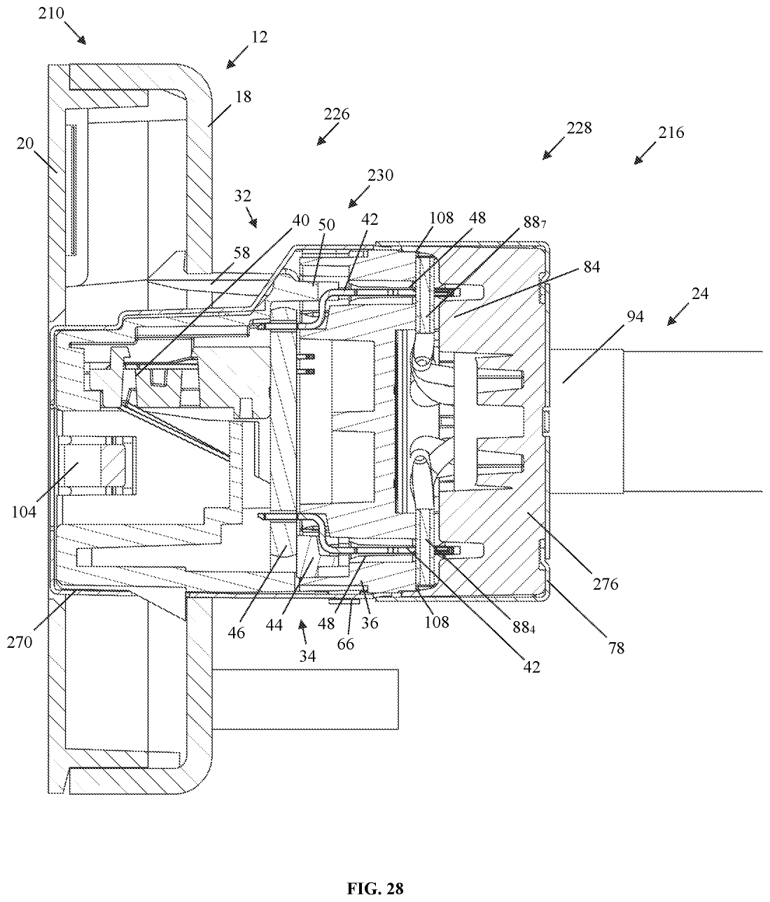

FIG. 28 is a section view of communications system 210 taken about the center line of conductor 88₄ and conductor 88₇ of an unmated terminated jack assembly 216 secured to shielded patch panel 12. Conductors 88 on shielded cable 24 are pressed into slots 86 (FIG. 7-FIG. 14) of rear sled 36 and terminated to long IDCs 42 of jack housing assembly 226. Cut edge 108 on rear sled 36 provides a flat surface for a punchdown tool to trim conductors 88 flush. Shielded cable 24 has to be fed through rear wire cover assembly 228 prior to conductors 88 getting terminated to long IDCs 42 of jack housing assembly 226. Rear wire cover assembly 228 is then placed over the back end of jack housing assembly 226. If the ends of conductors 88 are cut too long or cut without the use of a punchdown tool after termination; angled faces 110 (FIG. 7-FIG. 14) allow users to trim excess length of conductors 88 with a pair of flat edge snips.

Copper foil tape 294 is adhered over either a braid or drain wire from shielded cable 24 to create a smooth electrically conductive bonding surface. Grounding prongs 292 on wire cover shield wrap 278 of rear wire cover assembly 228 bond to copper foil tape 294 of shielded cable 24 as wire cover shield wrap 278 is placed into its final position to provide 360-degree shielding. Mandrels 290 on wire cover 276 provide a controlled surface for grounding prongs 292 on wire cover shield wrap 278 to wrap around and prevent plastic deformation, as shielded cable 24 is placed into rear wire cover assembly 228. Preventing grounding prongs 292 from plastically deforming ensures continuity between rear wire cover assembly 228 and copper foil tape 294 if a plurality of terminations occurs. Wiping tabs 96 (FIG. 23-FIG. 24) on front shield wrap 230 of jack housing assembly 226 make connection to inside walls 298 (FIG. 25-FIG. 27) on wire cover shield wrap 278 of rear wire cover assembly 228 to create a fully bonded assembly. Capture slots 300 (FIG. 25-FIG. 27) on wire cover 276 of rear wire cover assembly 228 pass over round bosses 102 (FIG. 7-FIG. 14) on rear sled 36 of jack housing assembly 226 and secure rear wire cover assembly 228 to finalize terminated jack assembly 216. Divider walls 284 on wire cover 276 of rear wire cover assembly 228 slide into slots 286 of rear sled 36 of jack housing assembly 226 and help to secure conductors 88 on shielded cable 24.

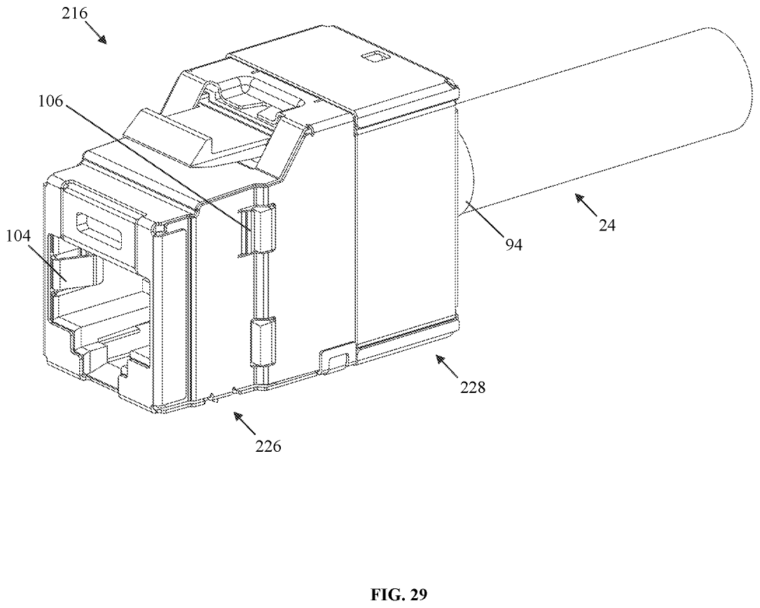

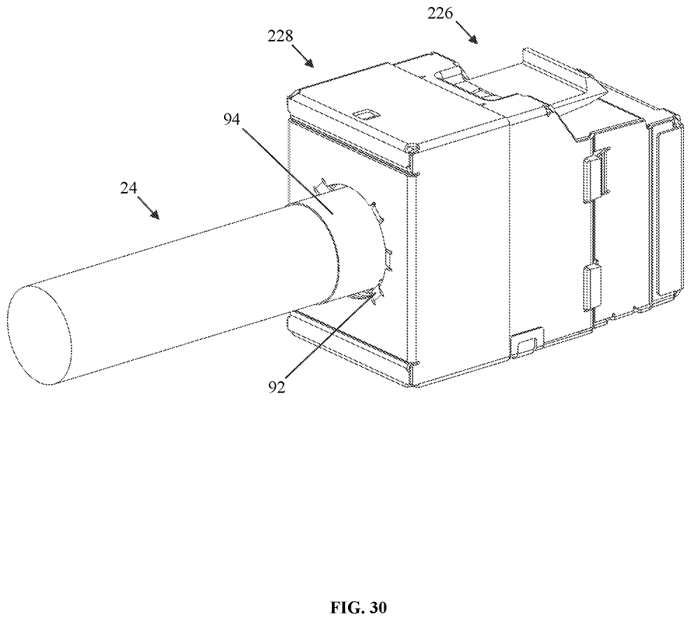

FIG. 29 is a front top view of terminated jack assembly 216. FIG. 30 is a rear top view of terminated jack assembly 216. Inner wiping tabs 104 provide a bond between plug shield 23 (FIG. 1) on shielded plug assembly 22 when shielded plug assembly 22 and terminated jack assembly 216 are in a mated state. Grounding tabs 106 are designed to bond terminated jack assembly 216 to shielded patch panel 12 when parts are assembled.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A keystone style punchdown jack assembly comprising
a jack housing assembly, the jack housing assembly having a front shield wrap; and
a rear wire cover assembly having a rear wire cover shield wrap with an opening configured to fully encircle a cable to be inserted into the keystone style punchdown jack, the rear wire cover assembly also having grounding prongs extending from the opening configured to engage a grounding braid of the inserted cable and wherein the front shield wrap has wiping tabs configured to engage inside walls of the rear wire cover in order to create a fully bonded assembly.
